(19) United States
(12) Patent Application Publication
(10) Pub. No.: US 2014/0120546 A1
(43) Pub. Date: May 1, 2014

(54) METHOD OF PROCESSING A SAMPLE FOR ANALYSIS

(71) Applicants: Neil Percy, St. Paul, MN (US); Gregory W. Sitton, Minneapolis, MN (US)

(72) Inventors: Neil Percy, St. Paul, MN (US); Gregory W. Sitton, Minneapolis, MN (US)

(73) Assignee: 3M INNOVATIVE PROPERTIES COMPANY, St. Paul, MN (US)

(21) Appl. No.: 14/119,363

(22) PCT Filed: Jun. 11, 2012
(86) PCT No.: PCT/US12/41851

§ 371 Date: Nov. 21, 2013

Related U.S. Application Data
(60) Provisional application No. 61/496,671, filed on Jun. 14, 2011.

(51) Int. Cl. G01N 1/30

(52) U.S. Cl. CPC G01N 1/30
USPC 435/6.12; 435/7.92; 435/309.1

(57) ABSTRACT

A method of processing a sample for analysis is disclosed. The method includes providing a sample, a container, and a cap comprising an elastically-deformable slit. The method further includes affixing the cap to the container, depositing the sample into the container, and exposing the sample to a temperature about 85-100° C. to form a cell lysate. The method further can comprise detecting an analyte in the sample. A kit comprising at least one of the containers, at least one of the caps, and a reagent that facilitates cell lysis is also provided. Optionally, the kit can further comprise a detection reagent.

### CROSS REFERENCE TO RELATED APPLICATIONS

This application claims the benefit of U.S. Provisional Patent Application No. 61/496,671, filed Jun. 14, 2011, which is incorporated herein by reference in its entirety.

### BACKGROUND

Applications of nucleic acid, protein, or antigen testing are broad. The majority of current commercial testing relates to infectious diseases including Chlamydia, gonorrhea, hepatitis and human immunodeficiency virus (HIV) viral load; genetic diseases including cystic fibrosis; coagulation and hematology factors including hemochromatosis; and cancer. Food and beverages are also tested for the presence or absence of potentially-pathogenic microorganisms. The majority of testing currently occurs in centralized laboratories using non-portable and operationally complex instruments. Presently, tests generally require highly skilled individuals to perform the assays.

Nucleic acids found in cells can be deoxyribonucleic acid or ribonucleic acid and can be genomic DNA, extrachromosomal DNA (e.g. plasmids and episomes), mitochondrial DNA, messenger RNA and transfer RNA. Nucleic acids can also be foreign to the host and contaminate a cell as an infectious agent, e.g. bacteria, viruses, fungi or single celled organisms and infecting multicellular organisms (parasites).

The detection of non-nucleic acid materials (e.g., proteins, polysaccharides) is also used to detect the presence or absence of a microorganism in a sample or in the environment. Immunochromatography and ELISA tests can be used to detect the presence of such molecules.

Methods of extracting analytes (e.g., nucleic acids, proteins) from cells are known to those skilled in the art. The specific method of nucleic acid, protein, or polysaccharide extraction may be dependent on the type of molecule to be isolated, the type of cell, and the specific application used to analyze the molecule. Many methods of isolating DNA are known to those skilled in the art, see for example the general reference Sambrook and Russell, 2001, “Molecular Cloning: A Laboratory Manual”.

Methods of releasing nucleic acids from cells are well known to those skilled in the art. Typically, cell disruption is performed using mechanical means (e.g., sonic vibration, heat) and/or chemical means (e.g., strong base, detergent, chaotropic agents).

There is a need for efficient methods to test for the presence of pathogenic microorganisms in a sample.

### SUMMARY

In general, the invention is directed to a method for assessing the microbiological content of a sample (e.g., a sample of food or water, an environmental sample). In particular, the inventive method can be used to prepare a sample to detect the presence or absence of a target microorganism. The method includes heating the sample, which can cause the lysis of cells (e.g., microorganism cells) and/or facilitate the detection of an analyte associated with a cell.

In one aspect, the present disclosure provides a method of processing a sample for analysis. The method can comprise providing a sample, a container, and a cap. The container can comprise at least one wall that forms an opening and a reservoir. The cap can be shaped and proportioned to seal the opening. The cap can comprise an upper surface, a lower surface and an elastically-deformable slit extending from the upper surface to the lower surface. The method further can comprise affixing the cap to the container, depositing the sample into the container, and exposing the sample to a temperature about 85-100° C. to form a cell lysate.

In any of the above embodiments of the method, providing a container further can comprise providing a container with the reagent disposed therein. In some embodiments, the reagent can facilitate cell lysis, wherein the method further can comprise forming a mixture comprising the sample and the reagent that facilitates cell lysis. In some embodiments, the reagent that facilitates cell lysis can be selected from the group consisting of a detergent, and antibiotic, and a polypeptide.

In any of the above embodiments, wherein providing a container further can comprise providing a container with a liquid disposed in the reservoir.

In any of the above embodiments, after the exposing the sample to an elevated temperature, the method further can comprise removing a portion of the sample from the reservoir.

In some embodiments, removing a portion further can comprise using a sample transfer article to withdraw the portion. In these embodiments, the sample transfer article can comprise a length index. In these embodiments, using the sample transfer article further can comprise using the length index to insert the sample transfer article to a predefined region in the reservoir.

In any of the above embodiments, the method further can comprise detecting the presence or absence of a biological analyte.

In another aspect, the present disclosure provides a kit. The kit can comprise at least one container configured to prepare a sample for analysis, a cap adapted to couple to the at least one container, and a reagent that facilitates cell lysis. The at least one container can have a wall that forms an opening and a reservoir. The cap can be shaped and proportioned to seal the opening. The cap can include an upper surface, a lower surface and an elastically-deformable slit extending from the upper surface to the lower surface.

In any embodiment of the kit, providing a cap can further comprise providing an article comprising a plurality of connected, spaced-apart caps, wherein each spaced-apart cap is shaped and proportioned to seal the opening of one of the plurality of containers. In any embodiment of the kit, providing a container can further comprise providing a container having a liquid disposed in the reservoir. In any embodiment, the kit can further comprise a detection reagent or a detection device.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

“Sample”, as used herein, refers to the biological material comprising an analyte to be detected. In some embodiments, the sample can be a substantially raw sample, which has not been subjected to purification and/or concentration processes. In some embodiments, the sample can be a concentrated and/or purified sample, which has been subjected to one or more processes to increase the concentration and/or homogeneity of the analyte, relative to the raw sample. The analyte may be a whole microorganism or a biomolecule that is associated with a particular microorganism or a group of microorganisms.

The terms “comprises” and variations thereof do not have a limiting meaning where these terms appear in the description and claims.

As used herein, “a,” “an,” “the,” “at least one,” and “one or more” are used interchangeably. Thus, for example, a microorganism can be interpreted to mean “one or more” microorganisms.

The term “and/or” means one or all of the listed elements or a combination of any two or more of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

Additional details of these and other embodiments are set forth in the accompanying drawings and the description below. Other features, objects and advantages will become apparent from the description and drawings, and from the claims.

### BRIEF DESCRIPTION OF DRAWINGS

FIG. 1 is an exploded side view of one embodiment of a container with a cap according to the present disclosure.

FIGS. 2A and 2B are plan views of the upper and lower surfaces, respectively, of the cap of FIG. 1.

FIG. 3 is a block diagram of one embodiment of a method of processing a sample according to the present disclosure.

FIG. 4 is a cross-sectional side view of one embodiment of a sample transfer article with a length index, according to the present disclosure.

FIG. 5A is a cross-sectional side view of the sample transfer article of FIG. 4 adjacent the assembled cap and container of FIG. 1.

FIG. 5B is a cross-sectional side view of the sample transfer article and assembled container of FIG. 5A, with the sample transfer article inserted through the cap to a first position.

FIG. 5C is a cross-sectional side view of the sample transfer article and assembled container of FIG. 5A, with the sample transfer article inserted through the cap to a second position.

### DETAILED DESCRIPTION

The invention is directed to a method of processing a sample for analysis. In particular, the method includes heating a sample to a temperature sufficient to lyse cells and/or release detectable biomolecules from the surface or interior of the cells. Advantageously, the sample is heated in a container that includes a cap with a slit. The slit is elastically deformable, thereby easily permitting the insertion of a sample transfer device to deposit the sample into the container and to withdraw all or a portion of the sample after heating. Advantageously, the slit prevents substantial loss of the sample during the heat treatment and it prevents the entry of contaminants during the preparation of the sample.

In one aspect, a method according to the present disclosure comprises providing a sample, a container, and a cap coupled thereto. The container comprises at least one wall that forms an opening and a reservoir. The cap is shaped and proportioned to seal the opening. The cap further comprises an upper surface, a lower surface and an elastically-deformable slit extending from the upper surface to the lower surface. The method further comprises depositing the sample into the container, and heating the sample to about 85-100° C.

Surprisingly, even though the container is open (i.e. via the slit) at all times, subjecting the container and its contents to near-boiling temperatures (about 95-100° C.) does not result in a significant loss of liquid and/or cross contamination of the contents when a plurality of the opened containers are heat-treated in close proximity to one another.

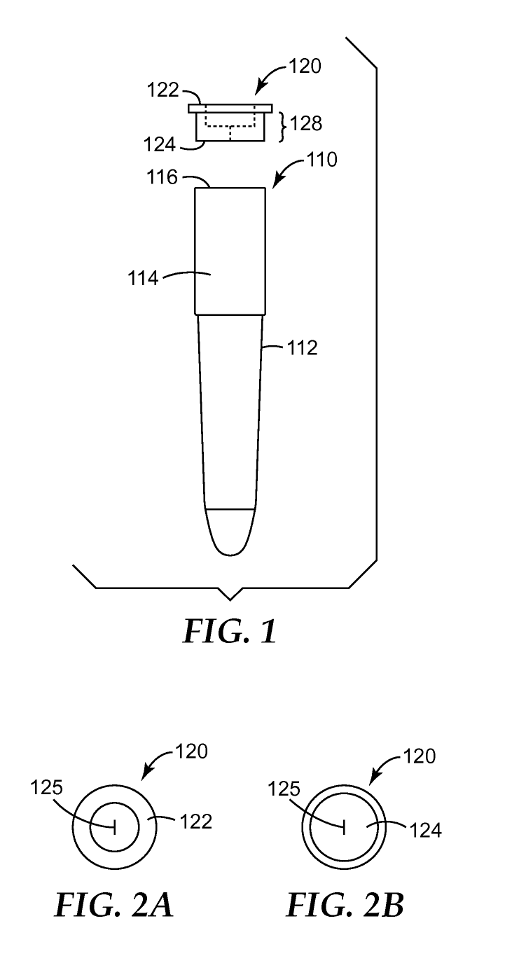

FIG. 1 shows an exploded side view of one embodiment of a container 110 with a cap 120, according to the present disclosure. The container 110 comprises at least one wall 112 that forms a reservoir 114. The container 110 further comprises an opening 116 that provides access to the reservoir 114. Although the illustrated embodiment of the container 110 resembles the shape of a tube that is closed at one end (e.g., a test tube or a microassay tube), it is contemplated that the container 110 could be configured in other shapes (e.g., similar to a flask, a microwell, and the like). The container 110 can be fabricated from a variety of materials such as, for example glass, metal, plastic, provided the material is compatible with the heating procedure and, if applicable, an analyte detection procedure.

The cap 120 is dimensioned to form a closure covering the entire area of the opening 116. Thus, in some embodiments, the cap 120 is shaped and proportioned to seal the opening 116 of the container. The cap includes an upper surface 122 and a lower surface 124. The cap 120 further can include a projected portion 128, at least part of which can be inserted into the opening 116 of the container 110.

FIGS. 2A and 2B show plan views of the upper surface 122 and lower surface 124, respectively, of the cap 120 of FIG. 1. The cap 120 includes a slit 125 extending through the cap 120 from the upper surface 122 to the lower surface (124). A non-limiting example of a suitable cap 120 is the split-cap TPE plug style cap available from Micronic North America, LLC (McMurray, Pa.).

Optionally, the cap can be provided as a two-dimensional mat comprising a plurality of caps (e.g., the Pierceable TPE Capmat, available from Micronic North America, not shown). Alternatively, the cap can be provided as a one-dimensional strip (e.g., the Pierceable TPE Capband-8 or the TPE Capband 12, available from Micronic North America). Preferably, in the mat or the strip, the spacing between the caps matches the spacing typically used to separate containers when they are in use in use (e.g., the typical spacing used in a 96-well plate or heating block).

In some embodiments (not shown), a lubricant may be applied to the cap to facilitate the insertion of a sample-transfer device through the slit. For example, about 0.5 microliters of silicone oil (e.g., a 1000 cSt silicone oil) can be applied to the upper surface of the cap. Preferably, the lubricant can be applied to a portion of the cap proximate slit.

Providing a sample to be tested may comprise providing a sample that is suspected of containing a target microorganism. The sample can be any sample that may include a target microorganism as defined herein. Nonlimiting examples of suitable samples include environmental samples (e.g., surface swabs/sponges, soil, sediments, fomites), food (e.g., raw materials, in-process samples, and finished-product samples), beverages, clinical/veterinary samples (e.g., blood, serum, plasma, urine, sputum, tissue, mucous, feces, wound exudate, pus, cerebrospinal fluid), and water (e.g., surface water, potable water, process water).

In some embodiments, the presence or absence of a target microorganism can be analyzed in a test sample that is derived from a variety of food, beverage, or food- or beverage-processing environmental sources. Non-limiting examples of food sources include raw or processed meat, raw or processed fruits or vegetables, non-fluid dairy products (e.g., cheese, butter, and ice cream), nuts, spices, ingredients, and syrups. Non-limiting examples of beverage sources include potable water, fruit or vegetable juices, milk, and fermented beverages. Pasteurized food or beverages may also be suitable sources. Non-limiting examples of food- or beverage-processing environmental samples include food-handling surface samples (e.g., conveyor belts, blades, cutting surfaces, mixing equipment surfaces, filters, storage containers), room samples (e.g., walls, floors, drains, ventilation equipment), and cleaning equipment (e.g., hoses, cleaning tools).

In some embodiments, the presence or absence of a target microorganism can be analyzed in a sample that is derived from a variety of human or animal sources, such as a physiological fluid, e.g., blood, saliva, ocular lens fluid, synovial fluid, cerebral spinal fluid, pus, sweat, exudate, urine, mucus, lactation milk, or the like. Further, the test sample may be derived from a body site, e.g., wound, skin, nares, scalp, nails, etc.

Samples of particular interest from human or animal sources include mucus-containing samples, such as nasal samples (from, e.g., anterial nares, nasopharyngeal cavity, nasal cavities, anterior nasal vestibule, etc.), as well as samples from the outer ear, middle ear, mouth, rectum, vagina, or other similar tissue. Examples of specific musosal tissues include buccal, gingival, nasal, ocular, tracheal, bronchial, gastrointestinal, rectal, urethral, ureteral, vaginal, cervical, and uterine mucosal membranes.

Besides physiological fluids, other test samples may include other liquids as well as solid(s) dissolved or suspended in a liquid medium. Samples of interest may be obtained from process streams, water, soil, plants or other vegetation, air, surfaces (e.g., contaminated surfaces), and the like. Samples can also include cultured cells. Samples can also include samples on or in a device comprising cells, spores, or enzymes (e.g., a biological indicator device).

Suitable samples for methods of the present disclosure can include certain solid samples. Solid samples may be disintegrated (e.g., by blending, sonication, homogenization) and may be suspended in a liquid (e.g., water, buffer, broth). In some embodiments, a sample-collection device (e.g., a swab, a sponge) containing sample material may be used in the method. Alternatively, the sample material may be eluted (e.g., rinsed, scraped, expressed) from the sample-collection device before using the sample material in the method. In some embodiments, liquid or solid samples may be diluted in a liquid (e.g., water, buffer, broth).

The sample may comprise an indicator microorganism, as described herein. The indicator microorganism can be indicative of contamination (e.g., fecal contamination), infection (e.g., infection with a pathogenic microorganism), or an indicator of general sanitation (e.g., any aerobic microorganism). The indicator microorganism further can be a target microorganism.

Microorganisms of particular interest, which may be of interest as an indicator organism or a target microorganism, include prokaryotic and eukaryotic organisms, particularly Gram positive bacteria, Gram negative bacteria, fungi, mycoplasma, and yeast. Particularly relevant organisms include members of the family Enterobacteriaceae, or the family Micrococcaceae or the genera Staphylococcus spp., Streptococcus spp., Pseudomonas spp., Enterococcus spp., Salmonella spp., Legionella spp., Shigella spp. Yersinia spp., Enterobacter spp., Escherichia spp., Bacillus spp., Listeria spp., Vibrio spp., Corynebacteria spp. as well as herpes virus, Aspergillus spp., Fusarium spp., and Candida spp. Particularly virulent organisms include Staphylococcus aureus (including resistant strains such as Methicillin Resistant Staphylococcus aureus (MRSA)), S. epidermidis, Streptococcus pneumoniae, S. agalactiae, S. pyogenes, Enterococcus faecalis, Vancomycin Resistant Enterococcus (VRE), Vancomycin Resistant Staphylococcus aureus (VRSA), Vancomycin Intermediate-resistant Staphylococcus aureus (VISA), Bacillus anthracia, Pseudomonas aeruginosa, Escherichia coli, Aspergillus niger, A. fumigatus, A. clavatus, Fusarium solani, F. oxysporum, F. chlamydosporum, Listeria monocytogenes, Listeria ivanovii, Vibrio cholera, V. parahemolyticus, Salmonella cholerasuis, S. typhi, S. typhimurium, Candida albicans, C. glabrata, C. krusei, Cronobacter sakazakii, E. coli O157 and multiple drug resistant Gram negative rods (MDR).

Gram positive and Gram negative bacteria are of particular interest. Of particular interest are Gram positive bacteria, such as Listeria monocytogeness. Also, of particular interest are antibiotic resistant microbes including MRSA, VRSA, VISA, VRE, and MDR microbes.

In some embodiments, the sample can be mixed, suspended, and/or diluted in a liquid suspending medium. The liquid suspending medium can be an aqueous liquid such as water or a buffer solution (e.g., phosphate-buffered saline), for example. Samples comprising solid material can be suspended, and optionally homogenized, in the liquid suspending medium.

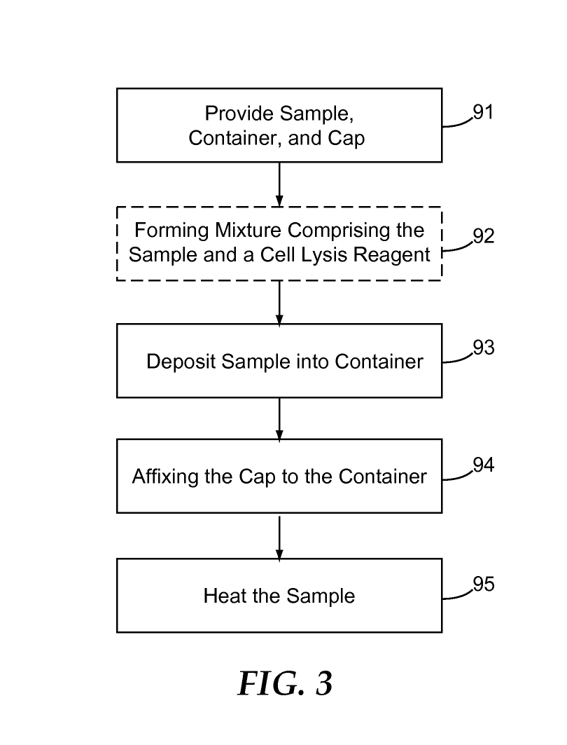

FIG. 3 shows a block diagram of one embodiment of a method according to the present disclosure. The method includes the step 91 of providing a sample, a container, and a cap. The sample can be any sample as described herein. In some embodiments, the sample comprises an aqueous liquid. In some embodiments, the sample is suspended or diluted in an aqueous liquid. Typically, the sample is suspected of including a target analyte. In some embodiments, the target analyte may be a biomolecule (e.g., a protein, a polynucleotide, an antigen) associated with the presence of a microorganism (e.g., a bacterium, a yeast, a mold, a virus, a protozoan, or an alga). The container includes an opening and can be any suitable container described herein. The cap is shaped and proportioned to seal the opening and can be any suitable cap as described herein. The cap comprises an upper surface, a lower surface and an elastically-deformable slit extending from the upper surface to the lower surface.

In any embodiment, providing a container may further comprise providing a container with a reagent disposed therein. The reagent may facilitate cell lysis. In some embodiments, the reagent may be dissolved and/or suspended in an aqueous liquid. In some embodiments, the reagent may be substantially water-free (e.g., a dry powder or a dried-down liquid coating).

In any embodiment, providing a container may further comprise providing a container with a liquid disposed therein. In some embodiments, the liquid may comprise an aqueous suspending medium and/or diluent such as, for example, water, a saline solution, or an aqueous buffer solution. In some embodiments, a reagent may be dissolved and/or suspended in the liquid.

The method further comprises the step 93 of depositing the sample into the container. Typically, the sample comprises a liquid and/or is suspended in a liquid. The liquid-containing sample can be deposited into the container using a sample-transfer device such as a pipette, for example. If the cap is already present on the container, the cap may be removed before the sample is deposited into the container or the sample may be deposited into the container by inserting a sample transfer device containing the sample through the slit into the reservoir of the container and depositing the sample. In any embodiment, the sample can be deposited into the container via the opening. In these embodiments, the cap can be affixed to the container (FIG. 3, step 94) after the sample is deposited into the container.

In any embodiment (not shown), the cap can be affixed to the container before the sample is deposited into the container. In these embodiments, the sample can be deposited into the container by inserting a sample-transfer device (e.g., a pipette, a pipette tip) through the slit in the cap and releasing the sample into the reservoir of the container.

According to step 94, the method comprises affixing the cap to the container. In some embodiments, the cap can be affixed by press-fitting or friction-fitting a portion (e.g. a projected portion) of the cap into the opening of the container. Additionally or alternatively, the cap can be affixed to the container using an adhesive to form a seal between the cap and the opening and/or the wall of the container (not shown).

The method further comprises the step 95 of heating the sample. In any embodiment, heating the sample can comprise exposing at least a portion of the container to an elevated temperature (e.g. between 85° C. and 110° C., inclusive). In any embodiment, heating the sample can comprise exposing the sample to a temperature about 85° C. In any embodiment, heating the sample can comprise exposing the sample to a temperature about 90° C. In any embodiment, heating the sample can comprise exposing the sample to a temperature about 95° C. In any embodiment, heating the sample can comprise exposing the sample to a temperature greater than or equal to 95° C. In a preferred embodiment, heating the sample can comprise exposing the sample to a temperature of 95-100° C. In any embodiment, heating the sample can comprise exposing the sample to a temperature about 96° C. In any embodiment, heating the sample can comprise exposing the sample to a temperature about 97° C. In any embodiment, heating the sample can comprise exposing the sample to a temperature about 98° C. In any embodiment, heating the sample can comprise exposing the sample to a temperature about 99° C. In any embodiment, heating the sample can comprise exposing the sample to a temperature about 100° C.

Typically, heating the sample comprises exposing at least a portion of the container (e.g., the portion of the container holding the sample) to an elevated temperature. Preferably, the portion of the container exposed to an elevated temperature includes a portion of the container holding the sample. More preferably, the portion of the container exposed to an elevated temperature includes the entire portion of the container holding the sample. In some embodiments, the portion of the container exposed to an elevated temperature includes the entire container.

The sample and/or container may be heated using any suitable means known in the art. For example, in some embodiments, the container may be placed in an incubator, an oven, a heating block, an oil bath, a water bath or the like. In some embodiments, the sample and/or the container may be heated by exposure to sonic vibration (e.g., microwave irradiation).

In any embodiment, the method can comprise the optional step 92 of forming a mixture comprising the sample and a reagent to facilitate cell lysis. A “reagent to facilitate cell lysis”, as used herein, refers to a chemical or biological reagent that facilitates the disruption of a cell wall and/or cell membrane. Non-limiting examples of cell lysis reagents include detergents (e.g., sodium laurylsulfate, TRITON X-100), antibiotics (penicillin, a β-lactam antibiotic), and polypeptides (e.g. proteases such as trypsin or proteinase K, for example; lysozyme; lysostaphin; phage lysins; porins, and the like).

In some embodiments, it may be advantageous to process simultaneously a plurality of samples using the method of the present disclosure. In these embodiments, a plurality of containers (e.g., microtubes) can be placed in an appropriate holder (e.g., tube rack) such that the spacing is suitable for the use of a multichannel pipettor (e.g. a Rainin PIPET-LITE LTS 12-channel (20 μl to 200 μl) multichannel pipette (Mettler Toledo, Columbus, Ohio). Individual caps may be affixed to each of the plurality of containers or a strip or a mat comprising a plurality of caps may be used to affix a cap to each of the plurality of containers either before or after depositing a sample into each of the plurality of containers. A multichannel pipettor can be used to deposit simultaneously, optionally through the slits in each cap, a sample into each of the plurality of containers. After depositing the samples into the containers, the plurality of containers can be exposed to an elevated temperature, as described herein.

Thus, the present disclosure provides a method of processing a plurality of samples for analysis. The method can comprise providing a plurality of samples, a plurality of containers, and a plurality of caps. Each of the plurality of containers can comprise at least one wall that forms an opening and a reservoir. Each of the plurality of caps can include an outer surface, an inner surface, and an elastically-deformable slit. The method further can comprise affixing the plurality of caps to the plurality of containers. The method further can comprise depositing the plurality of samples into the plurality of containers and exposing at least a portion of each of the plurality of containers to an elevated temperature (e.g. between 85° C. and 110° C., inclusive). In some embodiments, the method can comprise exposing at least a portion of each of the plurality of containers to a temperature greater than or equal to 85° C. In some embodiments, the method can comprise exposing at least a portion of each of the plurality of containers to a temperature greater than or equal to 90° C. In some embodiments, the method can comprise exposing at least a portion of each of the plurality of containers to a temperature greater than or equal to 95° C. In some embodiments, the method can comprise exposing at least a portion of each of the plurality of containers to a temperature about 100° C. In some embodiments, the method can comprise exposing at least a portion of each of the plurality of containers to a temperature from 95-100° C. In some embodiments, the method further can comprise the step of forming a mixture comprising the sample and a reagent to facilitate cell lysis, as described herein.

After the sample has been exposed to an elevated temperature, as described herein, a portion of the sample can be removed from the reservoir of the container. The portion can be removed by inserting a sample transfer article (e.g., a pipette or a pipette tip) through the slit in the cap, drawing (e.g., by negative pressure) a portion or the entire sample into the sample transfer article, and withdrawing the sample transfer article from the container. The portion can be analyzed to detect the presence or absence of an analyte by any suitable detection method known in the art. Non-limiting examples of suitable detection methods include ELISA, immunochromatography, nucleic acid amplification tests (e.g., PCR, RT-PCR, Hot-Start PCR, Quantitative PCR, Cycle Sequencing), isothermal amplification methods (e.g., NASBA, IRA, RCA, LCR, TMA, SDA, ELIDA, NEAR, RPA, and LAMP), and non-amplified nucleic acid tests (e.g., Southern blot, dot blot). Methods of the present disclosure can be used to prepare a sample for the detection of an analyte as disclosed in U.S. Patent Application No. 61/478,251, filed on Apr. 22, 2011, and entitled, “LUMINESCENCE DETECTION METHOD”, which is incorporated herein by reference in its entirety.

In any of the embodiments, when a portion of the sample is withdrawn from the container, the method further can comprise using a sample transfer article to withdraw the portion, wherein the sample transfer article comprises a length index. A length index is a visible structure or a mark, on or in the sample transfer article, which defines a predetermined distance from the opening through which the sample is drawn into the sample transfer article.

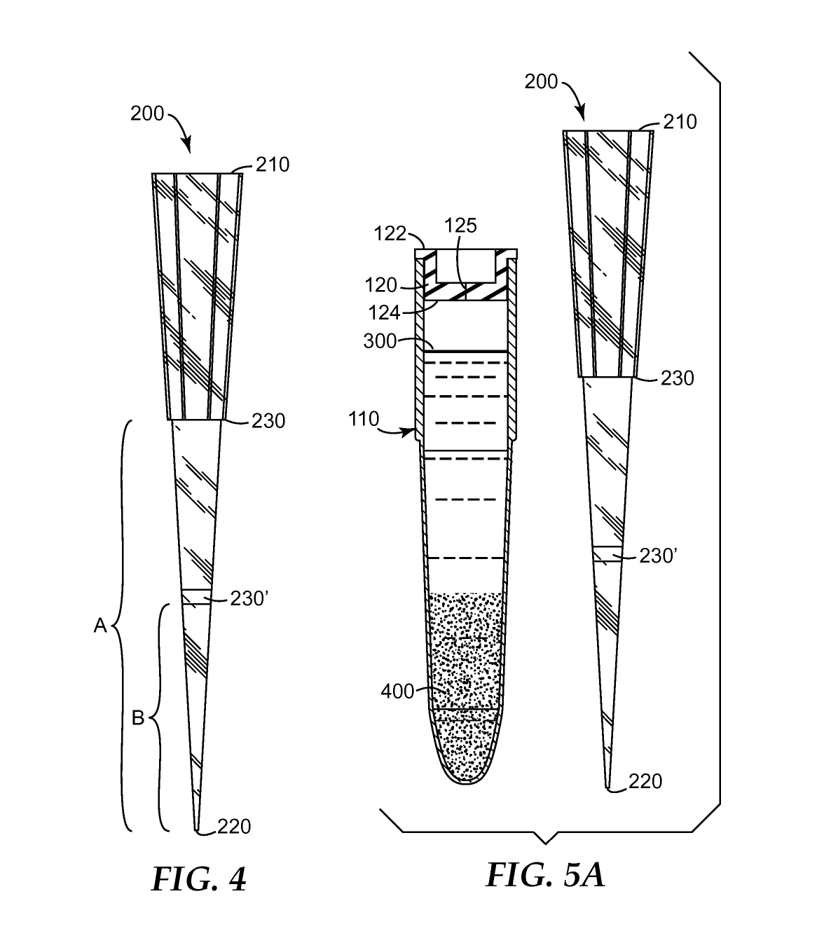

FIG. 4 shows a side view of one embodiment of a sample transfer article 200 with a plurality of length indexes. The sample transfer article 200 comprises a typical micropipette tip, such as the 20-ml Filter pipette tip available from Globe Scientific (Paramus, N.J.). The sample transfer article 200 comprises a first end 210 and a second end 220 opposite the first end 210, each end comprising an opening (not shown). A liquid sample (not shown) is drawn into the sample transfer article 200 through the opening at the second end 220 (e.g., by attaching the sample transfer article to a micropipettor and using the micropipettor to create negative pressure in the sample transfer article 200. Also shown in FIG. 4 is a first length index 230 (i.e., the visible edge of a visible projection) that is located a first predefined distance (“A”) away from the second end 220. In the illustrated embodiment, the sample transfer article 200 further comprises a second length index 230′ (e.g., a visible filter disposed in the pipette tip) that is also located a second predefined distance (“B”) away from the second end 220.

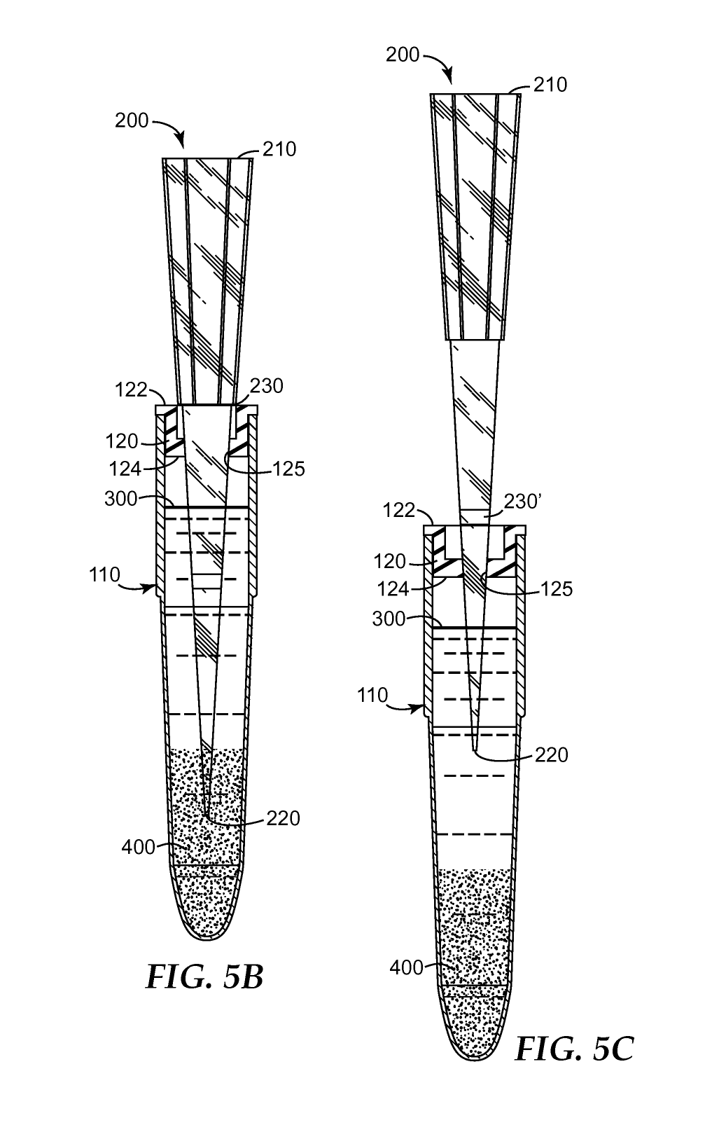

FIG. 5A-C show a cross-sectional side views of the container 110 and cap 120 of FIG. 1 and the sample transfer article 200 of FIG. 4. In FIG. 5A, the sample transfer article 200 is positioned adjacent the container 110. The container 110 holds a liquid sample 300, in which solid particulates 400 are suspended. The solid particulates may be, for example, particulates (e.g., dirt particles, food particles) that are present in the original sample. When such particulates are present, advantageously, the heating step of the present method can result in the release of analyte material from microorganisms that are avidly bound to the particulates. Thus, the method allows for the detection of microorganisms attached to or otherwise associated with a particulate material.

It is noted that, in the illustrated embodiment, the solid particulates 400 are somewhat denser than the liquid sample 300 and, even though it remains suspended, settle to the lower portion of the container 110. The sample transfer article comprises a first end 210, a second end 220, and at least two visible length indexes (230 and 230′). The cap 120 comprises an upper surface 122, a lower surface 124, and a slit 125. The cap 120 is made from a material that can elastically deform when the second end 220 of the sample transfer article 200 is inserted through the slit 125

FIG. 5B shows the sample transfer article 200 inserted through the slit 125 into the container 110 wherein the second end 220 of the sample transfer article 200 is located at a first position relative to the cap 120. In this first position, the first length index 230, which is a first predefined distance away from the second end 220, is approximately even with the upper surface 122 of the cap 120. In this first position, the second end of the sample transfer article 200 is immersed in the liquid sample 300 in a position proximate the solid particulates 400. Thus, in this first position, when a portion of the liquid sample 300 is drawn into the sample transfer article 200, some of the sample-purification matrix 40 may be drawn simultaneously into the sample transfer article 200. Undesirably, the sample purification matrix 400 may exert a negative effect on a subsequent process (e.g., a detection reaction). Thus, it may be desirable to insert the sample transfer article 200 into the container 110 to a position where the second end 220 is immersed in the liquid sample 300 but is not proximate the sample-purification matrix 400.

FIG. 5C shows the sample transfer article 200 inserted through the slit 125 into the container 110 wherein the second end 220 of the sample transfer article 200 is located at a second position relative to the cap 120. In this second position, the second length index 230′, which is a second predefined distance away from the second end 220, is approximately even with the upper surface 122 of the cap 120. In this second position, the second end of the sample transfer article 200 is immersed in the liquid sample 300 in a position remote from the sample-purification matrix 400. Thus, in this second position, when a portion of the liquid sample 300 is drawn into the sample transfer article 200, it is unlikely that some of the sample-purification matrix 400 will be drawn simultaneously into the sample transfer article 200. Advantageously, this will prevent the transfer of a potentially-undesirable material from the container 110 into the sample transfer article 200. Even more advantageously, using an appropriate length index properly to position the sample transfer article 200 in the container 110, the operator does not need to see the actual position of the second end 220 of the sample transfer article when withdrawing the liquid sample 300. Therefore, this method can be used with containers through which the contents cannot readily be seen (i.e., relatively opaque or colored containers, containers with labels or opaque labels).

The present disclosure also provides kits. The kit may be used to prepare a sample or a plurality of samples for analysis. In some embodiments, the kits may be used to perform any method of sample preparation according to the present disclosure.

In one aspect, a kit can comprise at least one container configured to prepare a sample for analysis, a cap, at least one container, and a reagent that facilitates cell lysis. The at least one container has a wall that forms an opening and a reservoir. The cap is shaped and proportioned to seal the opening. The cap includes an upper surface, a lower surface and an elastically-deformable slit extending from the upper surface to the lower surface. The reagent that facilitates cell lysis can be a chemical or biological reagent that facilitates the disruption of a cell wall and/or cell membrane, as described herein. The reagent that facilitates cell lysis may be disposed in one or more containers of the at least one container.

In any embodiment, the cap further can comprise a plurality of connected, spaced-apart caps, wherein each spaced-apart cap is shaped and proportioned to seal the opening of one of the plurality of containers, as described herein. In any embodiment, the kit further can comprise a liquid disposed in the reservoir of the at least one container. In any embodiment, the kit further can comprise a detection reagent or a detection device, as described herein. In any embodiment, the kit can further comprise instructions for conduction any embodiment of the method according to the present disclosure.

The following method is exemplary of methods of processing a sample according to the present disclosure. A sample of raw food (25 g or ground turkey) is placed into a stomacher bag with 225 mL of enrichment broth. The enrichment broth may be a universal enrichment broth for facilitating the growth of a variety of microorganisms or it may be a selective enrichment broth that facilitates the growth of a relatively small group of target microorganisms. The sample is homogenized for 0.5-2 minutes. The homogenate is incubated for an appropriate period of time (e.g., overnight or between about 8-48 hours) at a temperature appropriate for the particular microorganism to be detected (e.g., between 25° C. and 44.5° C. After the incubation period, a portion (e.g., 20 microliters) of the broth is pipetted into a microtube (e.g., a 1.1 mL minitube, part number MTS-8-C-R, available from Axygen, Inc. Union City, Calif.), capped with a split-cap TPE plug style cap) containing about 500 microliters of a suitable cell lysis solution to facilitate the release of nucleic acid from a cell.

The contents of the tube are mixed for about 20 seconds using a vortex mixer and, subsequently, any solids that may be present in the mixture are allowed to settle for about 3 minutes. After the solids have settled, a sample of the liquid (e.g., about 20 microliters) is removed from the tube, taking care not to simultaneously remove the solids with the sample. This can be done using a micropipet with a suitable length index, as described herein. A nucleic acid analyte can be detected in the sample using any suitable nucleic acid amplification and detection system (e.g., PCR, rt-PRC) known in the art. In an alternative embodiment, a protein analyte can be detected using any suitable protein detection method (e.g., ELISA, immunochromatography) known in the art.

### EMBODIMENTS

Embodiment 1 is a method of processing a sample for analysis, comprising:

providing a sample, a container, and a cap;
wherein the container comprises at least one wall that forms an opening and a reservoir;
wherein the cap is shaped and proportioned to seal the opening, the cap comprising an upper surface, a lower surface and an elastically-deformable slit extending from the upper surface to the lower surface;

affixing the cap to the container,

depositing the sample into the container; and

exposing the sample to a temperature about 85-100° C. to form a cell lysate.

Embodiment 2 is the method of embodiment 1, wherein providing a container further comprises providing a container with the reagent disposed therein.

Embodiment 3 is the method of embodiment 2, wherein the reagent facilitates cell lysis, wherein the method further comprises:

forming a mixture comprising the sample and the reagent that facilitates cell lysis.

Embodiment 4 is the method of embodiment 3, wherein the reagent that facilitates cell lysis is selected from the group consisting of a detergent, and antibiotic, and a polypeptide.

Embodiment 5 is the method of any one of the preceding embodiments, wherein providing a container further comprises providing a container with a liquid disposed in the reservoir.

Embodiment 6 is the method of any one of the preceding embodiments, further comprising, after the exposing the sample to an elevated temperature, removing a portion of the sample from the reservoir.

Embodiment 7 is the method of embodiment 6, wherein removing a portion further comprises using a sample transfer article to withdraw the portion, wherein the sample transfer article comprises a length index, wherein using the sample transfer article further comprises using the length index to insert the sample transfer article to a predefined region in the reservoir.

Embodiment 8 is the method of any one of the preceding embodiments, further comprising detecting the presence or absence of a biological analyte.

Embodiment 9 is a kit, comprising:

at least one container configured to prepare a sample for analysis, a cap adapted to couple to the at least one container, and a reagent that facilitates cell lysis;

wherein the at least one container has a wall that forms an opening and a reservoir;
wherein the cap is shaped and proportioned to seal the opening, the cap including an upper surface, a lower surface and an elastically-deformable slit extending from the upper surface to the lower surface.

Embodiment 10 is the kit of embodiment 9, wherein the reagent that facilitates cell lysis is disposed in one or more of the at least one container.

Embodiment 11 is the kit of any one of embodiments 9 through 10, wherein providing a cap further comprises providing an article comprising a plurality of connected, spaced-apart caps, wherein each spaced-apart cap is shaped and proportioned to seal the opening of one of the plurality of containers.

Embodiment 12 is the kit of any one of embodiments 9 through 11, wherein the at least one container further comprises a liquid disposed in the reservoir.

Embodiment 13 is the kit of any one of embodiments 9 through 12, further comprising a detection reagent or a detection device.

Embodiment 14 is the kit of any one of embodiments 9 through 13, further comprising instructions for conducting the method of any one of claims 1 though 8.

The complete disclosure of all patents, patent applications, and publications, and electronically available material cited herein are incorporated by reference. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

Various modifications may be made without departing from the spirit and scope of the invention. These and other embodiments are within the scope of the following claims.

1. A method of processing a sample for analysis, comprising:
providing a sample, a container, and a cap;
wherein the container comprises at least one wall that forms an opening and a reservoir;
wherein the cap is shaped and proportioned to seal the opening, the cap comprising an upper surface, a lower surface and an elastically-deformable slit extending from the upper surface to the lower surface;
affixing the cap to the container,
depositing the sample into the container; and
exposing the sample to a temperature about 85-100° C. to form a cell lysate.

2. The method of claim 1, wherein providing a container further comprises providing a container with a reagent disposed therein.

3. The method of claim 2, wherein the reagent facilitates cell lysis, wherein the method further comprises:
forming a mixture comprising the sample and the reagent that facilitates cell lysis.

4. The method of claim 3, wherein the reagent that facilitates cell lysis is selected from a group consisting of a detergent, and antibiotic, and a polypeptide.

5. The method of claim 1, wherein providing a container further comprises providing a container with a liquid disposed in the reservoir.

6. The method of claim 1, further comprising, after the exposing the sample to a temperature about 85-100° C., removing a portion of the sample from the reservoir.

7. The method of claim 6, wherein removing a portion further comprises using a sample transfer article to withdraw the portion, wherein the sample transfer article comprises a length index, wherein using the sample transfer article further comprises using the length index to insert the sample transfer article to a predefined region in the reservoir.

8. The method of claim 1, further comprising detecting a presence or absence of a biological analyte.

9. A kit, comprising:
at least one container configured to prepare a sample for analysis, a cap adapted to couple to the at least one container, and a reagent that facilitates cell lysis;
wherein the at least one container has a wall that forms an opening and a reservoir;
wherein the cap is shaped and proportioned to seal the opening, the cap including an upper surface, a lower surface and an elastically-deformable slit extending from the upper surface to the lower surface.

10. The kit of claim 9, wherein the reagent that facilitates cell lysis is disposed in one or more of the at least one container.

11. The kit of claim 9, wherein providing a cap further comprises providing an article comprising a plurality of connected, spaced-apart caps, wherein each spaced-apart cap is shaped and proportioned to seal the opening of one of the plurality of containers.

12. The kit of claim 9, wherein the at least one container further comprises a liquid disposed in the reservoir.

13. The kit of claim 9, further comprising a detection reagent or a detection device.

14. The kit of claim 9, further comprising instructions for conducting the method of claim 1.
